(19) United States
(12) Patent Application Publication
(10) Pub. No.: US 2017/0124548 A1
(43) Pub. Date: May 4, 2017

(54) METHODS AND SYSTEMS FOR OPTIMIZING REWARD ACCOUNTS

(71) Applicant: PAYPAL, INC., San Jose, CA (US)

(72) Inventor: Raja Bolla, Austin, TX (US)

(21) Appl. No.: 14/932,633

(22) Filed: Nov. 4, 2015

(51) Int. Cl. G06Q 20/22; G06Q 20/32; G06Q 20/36; H04W 4/02; H04W 4/00

(52) U.S. Cl. CPC G06Q 20/227; H04W 4/023; H04W 4/008; G06Q 20/363; G06Q 20/3278

(57) ABSTRACT

Embodiments described herein disclose a mobile device system and method for determining suggested payment sources within an application executed by the mobile device. A location of the device may be detected. A merchant corresponding to the detected location may be identified, and characteristics of the merchant may be received. Additionally, non-public promotions offered by an entity associated with a stored payment source or with the merchant are received. Based on the payment sources, characteristics, and promotions, a suggested payment source for a transaction between the merchant and a user of the mobile device is determined and displayed on a touch-sensitive display. The suggested payment source may be selected by the user. Thus, the user is presented with a suggested payment source based on the merchant, and may maximize reward account points, cash back, or minimize interest, based on the suggestion of a payment source.

### BACKGROUND

Field

The present disclosure generally relates to electronic transactions conducted between devices and more particularly to a system and input interface that provides intelligent recommendations for a transaction to a consumer.

Related Art

More and more consumers are conducting transactions, such as searching for and purchasing, items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment services provider such as, for example, PayPal, Inc. of San Jose, Calif. Such payment services providers can make transactions easier and safer for the parties involved. Purchasing with the assistance of a payment services provider from the convenience of virtually anywhere using a mobile device is one main reason why on-line and mobile purchases are growing very quickly.

Additionally, many consumers may use applications provided by payment services providers to make purchases at traditional, brick-and-mortar establishments. Using these applications may permit the consumer to eliminate the need to carry credit cards, and can provide the user with the ability to manage multiple payment sources, loyalty programs, and other related information. Some payment sources or loyalty programs offer rewards or other incentives to the consumer or merchant for their use, such as a percentage of cash back or a certain amount of rewards points per dollar spent, but managing multiple payment sources and deciding which payment source to utilize for a given transaction may be difficult for consumers, leading to suboptimal reward results.

Thus, there is a need for an improved system and method for presenting and allowing a user to manage multiple payment sources.

### BRIEF DESCRIPTION OF THE FIGURES

FIG. 1 is a flow chart illustrating an embodiment of a method for providing suggested payment sources to a user;

FIG. 2a is a front view illustrating an embodiment of a touch-sensitive display device on a payer device displaying a mobile application provided by a payment services provider;

FIG. 2b is a front view illustrating an embodiment of a touch-sensitive display device on a payer device displaying a mobile application provided by a payment services provider with an indication of a detected merchant location;

FIG. 2c is a front view illustrating an embodiment of a touch-sensitive display device on a payer device displaying a mobile application provided by a payment services provider with a selection of detected merchant locations;

FIG. 2d is a front view illustrating an embodiment of a touch-sensitive display device on a payer device displaying a mobile application provided by a payment services provider with a suggested payment source;

FIG. 2e is a front view illustrating an embodiment of a touch-sensitive display device on a payer device displaying a mobile application provided by a payment services provider with an explanation of a suggested payment source;

FIG. 2f is a front view illustrating an embodiment of a touch-sensitive display device on a payer device displaying a mobile application provided by a payment services provider with a pop-up window having instructions of how to pay with a suggested payment source;

FIG. 2g is a front view illustrating an embodiment of a touch-sensitive display device on a payer device displaying a mobile application provided by a payment services provider with an indication of a directional touch gesture;

FIG. 2h is a front view illustrating an embodiment of a touch-sensitive display device on a payer device displaying a mobile application provided by a payment services provider with an indication of an offer to apply for a payment source;

FIG. 2i is a front view illustrating an embodiment of a touch-sensitive display device on a payer device displaying a mobile application provided by a payment services provider with a settings screen;

FIG. 3 is a schematic view illustrating an embodiment of a networked system;

FIG. 4 is a perspective view illustrating an embodiment of a payer device;

FIG. 5 is a perspective view illustrating a further embodiment of a payer device;

FIG. 6 is a schematic view illustrating an embodiment of a computer system; and

FIG. 7 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for providing, by an application, suggested payment sources to a user engaged in a transaction with a merchant. The application may be executed by a mobile device having location detection sensors, such as GPS location sensors, and a touch-sensitive display device. A location of the mobile device may be detected using the location sensors. The detected location may be transmitted to a payment services provider. A merchant corresponding to the detected location of the mobile device may be determined. The payment services provider then may transmit, for receipt by the mobile device, characteristics of the merchant corresponding to the location, and one or more promotional offers or promotions. The promotions may be offered by an entity associated with a stored payment source, or may be offered by the merchant. Based on the promotions, the payment sources, and the characteristics, a suggested payment source for the transaction may be determined. The suggested payment source may be displayed on the touch-sensitive display device, and a selection of the suggested payment source may be received from the user of the mobile device. As such, a user may be presented with relevant suggested payment sources based on his or her location, and may utilize a suggested payment source associated with a promotion or promotional offer, such as rewards points or cash back.

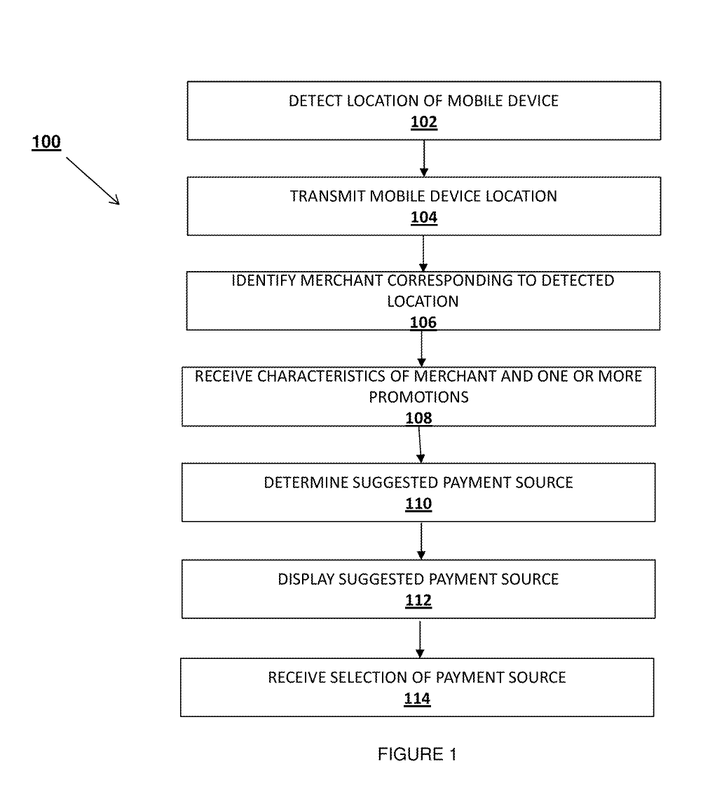

Referring now to FIG. 1, an embodiment of a method 100 for presenting recommended or suggested payment sources within an application on a mobile device with a touch-sensitive display device is described. In the embodiments and examples discussed below, system functionality is realized by an application provided by a payment services provider that may provide a user wallet functionality that allows the user to save one or more payment sources, payment instruments or other methods of payment, make payments to online and/or offline (e.g., brick-and-mortar) merchants using those payment instrument(s), transfer money to other users using those payment instrument(s), and/or provide other wallet functionality known in the art. However, the functionality described with respect to the embodiments disclosed herein is not limited to the aforementioned wallet functionality provided by the payment services provider, and instead may be implemented in other applications and uses such as, for example, a web browser, mapping applications, and/or other applications executed by a mobile device having a touch-sensitive display device.

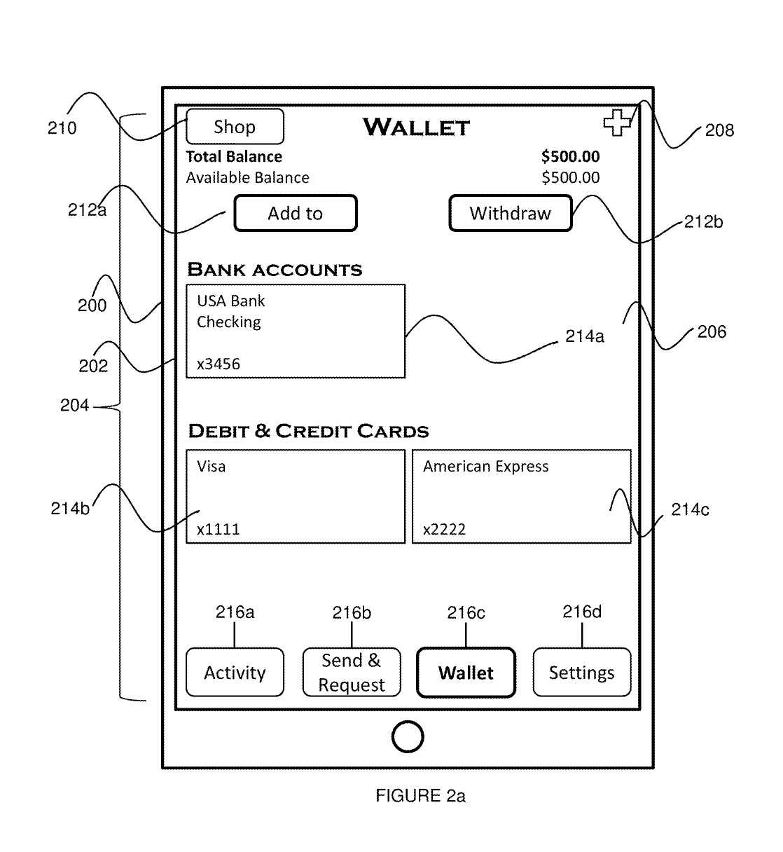

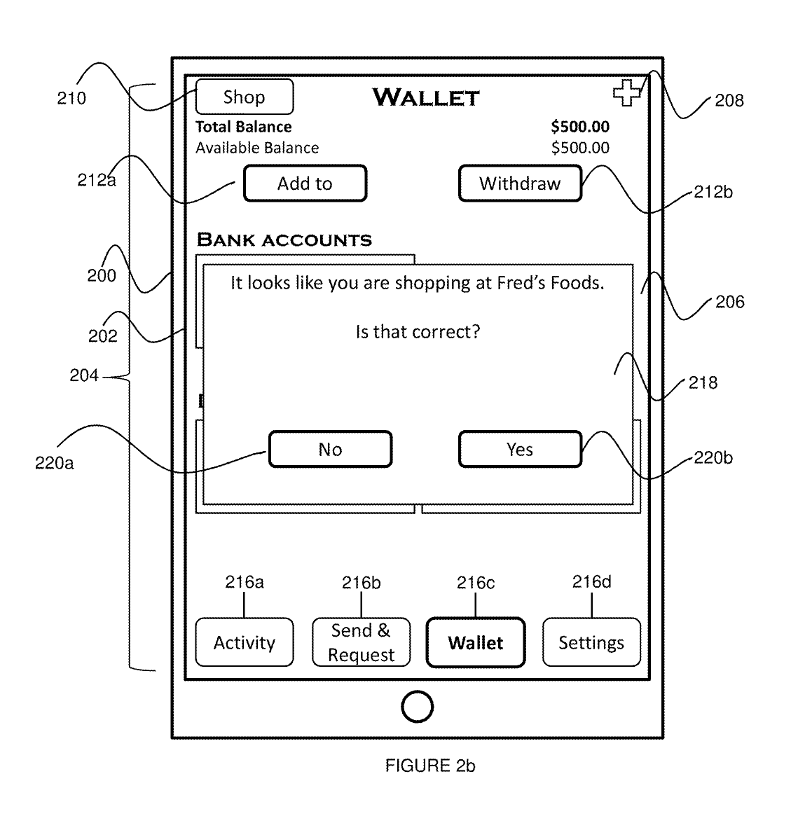

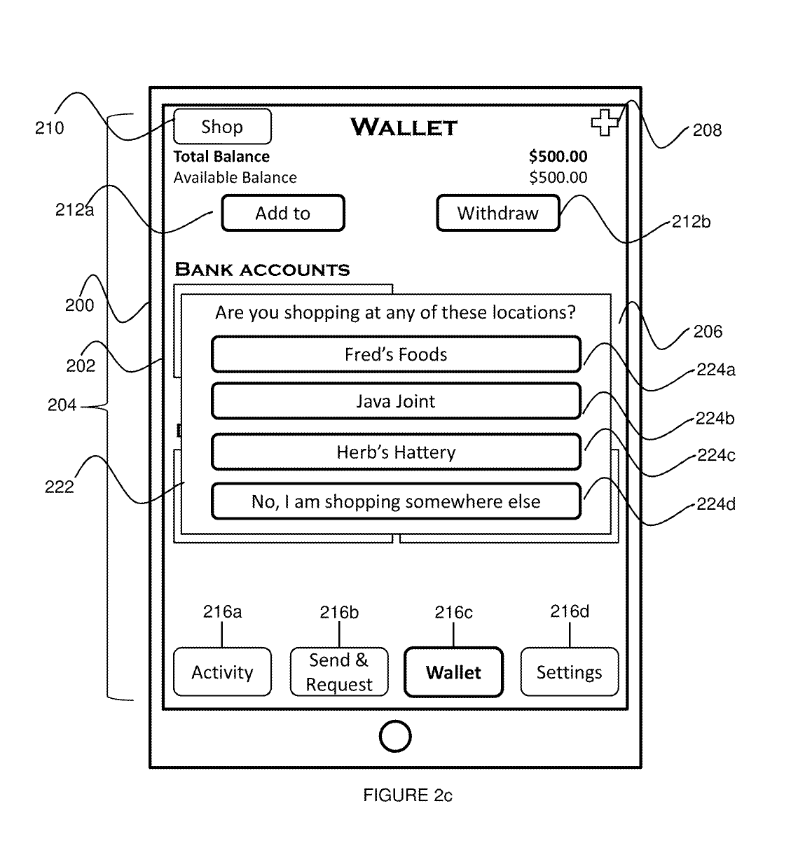

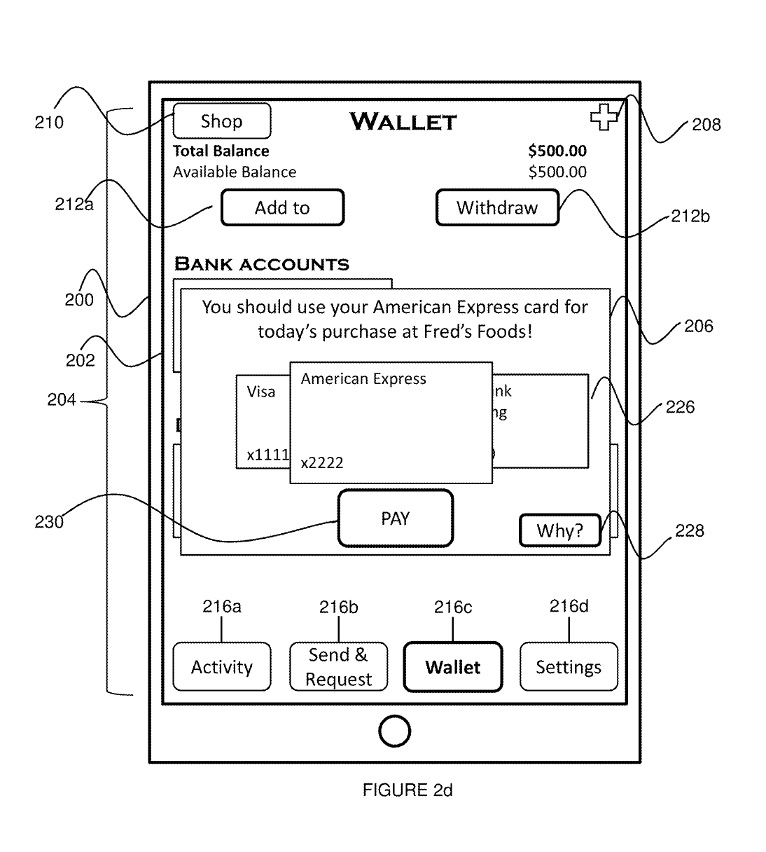

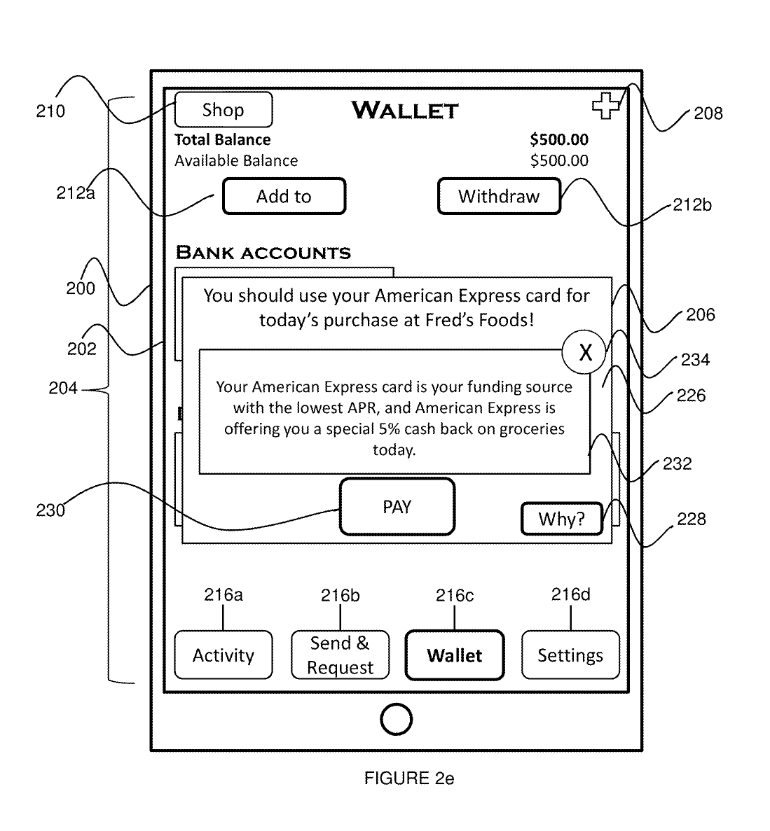

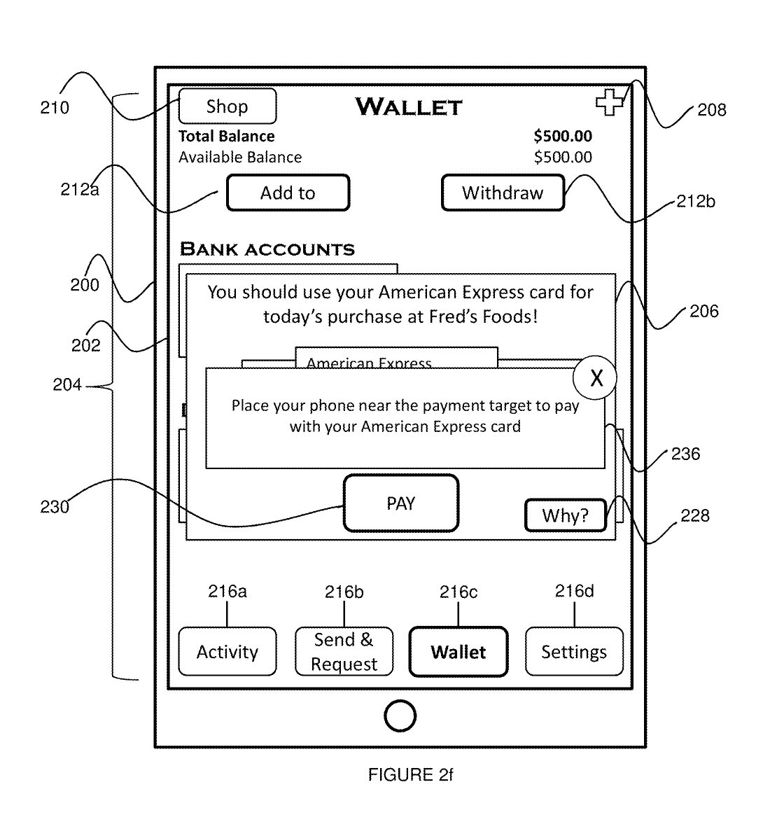

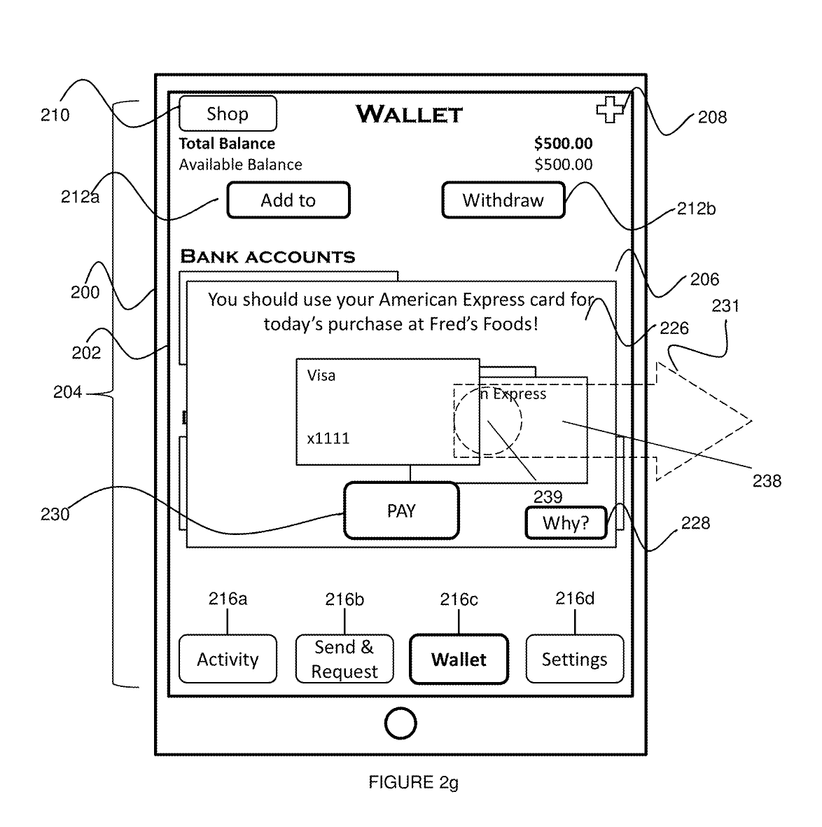

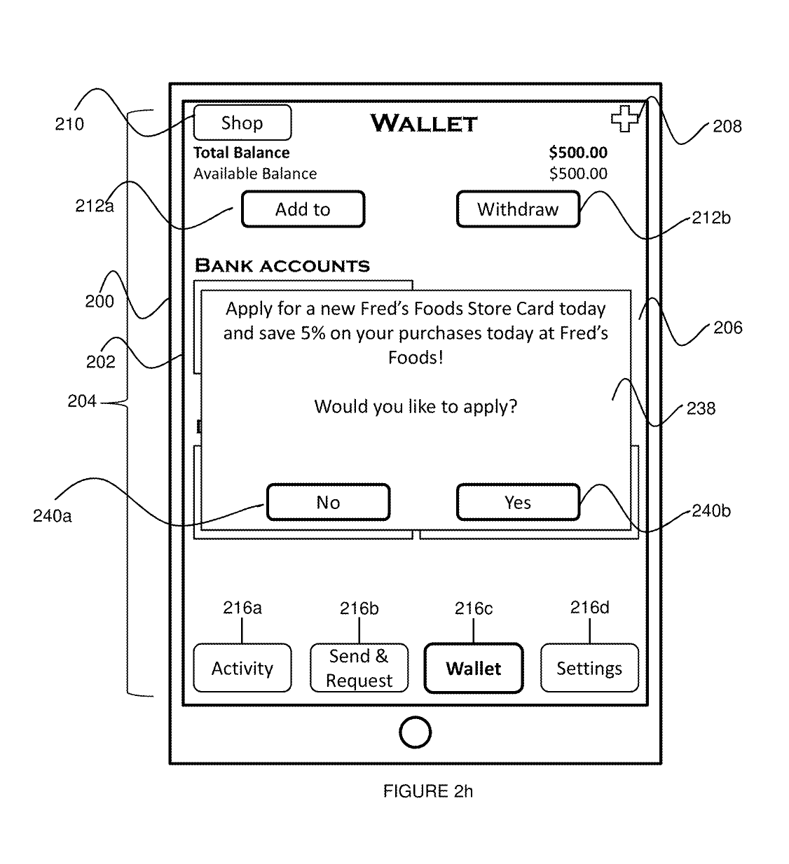

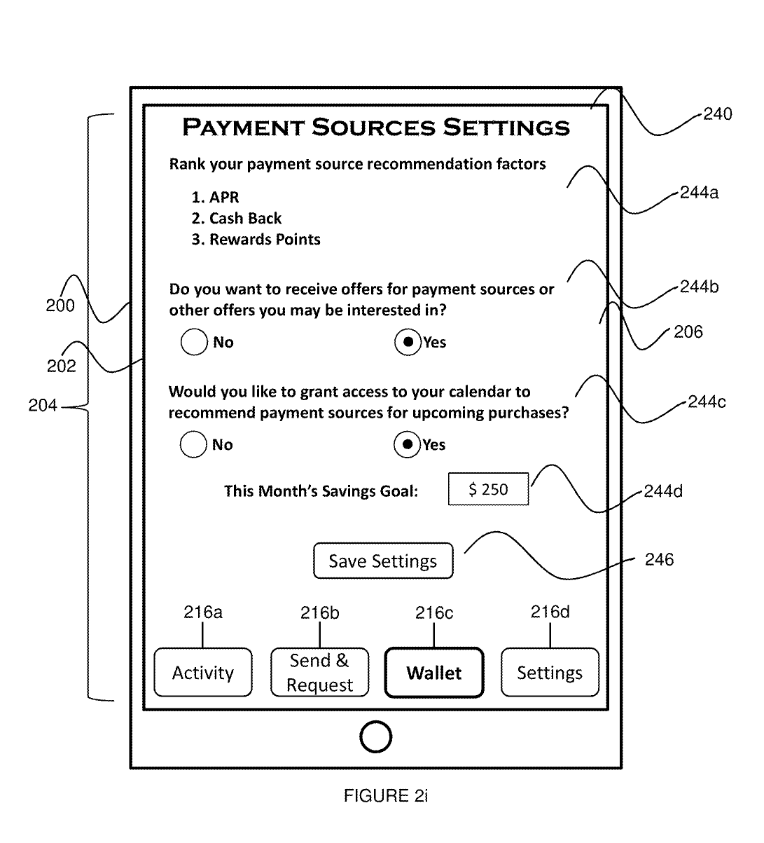

Referring first to FIG. 2a, a payer device 200 or mobile device includes a display 202 displaying payment application screen 204 that provides wallet functionality 206 of the payment application. As discussed above the payment application may be provided by a payment services provider, such as PayPal Inc. of San Jose, Calif., and the payer associated with the payer device may have a payment account with the payment services provider that allows the payer to access one or more financial accounts or payment sources for making payments to merchants or other users (e.g., credit financial accounts, banking financial accounts, virtual currency financial accounts, etc). The display 202 is a touch-sensitive or gesture-detecting display device, and may include multi-touch display device functionality that is capable of detecting multiple inputs at once from a user. The wallet functionality 206 of the payment application provides various functions, just a few of which are illustrated in FIG. 2a. For example, the wallet functionality 206 provides the current balance of the user's account with the payment services provider (e.g., $500 in the illustrated embodiment), and further provides a button 212a to allow the user to add funds to his or her account with the payment services provider (e.g., via a transfer from a financial account), and a button 212b to allow the user to withdraw funds from the account with the payment services provider (e.g., to a financial account or other user). Additionally, the wallet functionality 206 provides the financial accounts or payment sources associated with the user's account information, such as a bank account 214a, and credit cards 214b and 214c. The wallet functionality 206 also includes a button 208 to allow the user to add a new account, funding source, or payment source, such as a credit card, debit card, store loyalty card, gift card, bank account, virtual currency account, or other financial account to the user's account with the payment services provider. The wallet functionality 206 also provides a “shop” button 210 that may allow the user to purchase items from a merchant with the funds in the user's account with the payment services provider. As shown in FIG. 2a, the payment application provided by the payment services provider may include other functionality accessible by buttons 216a-216d. For example, button 216a may allow the user to view his or her activity with the payment services provider and/or financial accounts, button 216b may allow the user to send or request money from another user, button 216c (which is indicated as selected in FIG. 2a) provides access to the wallet functionality described above, and button 216d may allow the user to view and edit his or her settings or account information with the payment services provider.

The method 100 begins at block 102 where a location of a mobile device is detected. In one embodiment, the location of the mobile device may be detected by one or more location sensors, such as global positioning satellite (GPS) receivers included in a mobile device. In one embodiment, additional location detection sensors are used to detect the location of the mobile device. For example, the mobile device may utilize Wi-Fi triangulation to estimate the location of the mobile device, or may use information from cellular towers to estimate the location of the mobile device. In one embodiment, information from multiple location sensors may be used to increase the accuracy in determining the location of the mobile device. In one embodiment, location beacons, such as Bluetooth location beacons, may be used to increase the accuracy in determining the location of the mobile device. In one embodiment, the detection of the location may also include detection of an application executing on the mobile device, such as a shopping application.

The method 100 then proceeds to block 104 where the detected location of the mobile device is transmitted to a payment services provider. In one embodiment, the location is transmitted over a mobile network.

The method 100 then proceeds to block 106, where a merchant corresponding to the detected location of the mobile device is identified. In one embodiment, the merchant is identified by the payment services provider. In one embodiment, the merchant is identified by the mobile device of the user. In a further embodiment, the identification may be based on a combination of the merchant and the mobile device. For example, the payment services provider may identify a merchant corresponding to the detected location of the mobile device. The user may then be presented with a confirmation screen on a touch-sensitive display device to confirm whether the payment services provider's identification of the merchant corresponding to the detected location of the mobile device is correct. In one embodiment, the user may be presented with a list of potential merchants corresponding to the detected location of the mobile device, and may be asked to select a correct merchant using a display on a touch-sensitive display device of the mobile device. In one embodiment, the user may be asked to type in or search for the merchant corresponding to the detected location of the mobile device.

Referring now to FIG. 2b, the application may detect the location of the mobile device, and receive an identification of a merchant corresponding to the location from the payment services provider, or determine the merchant corresponding to the location within the application itself. Accordingly, the user may be presented with information such as that depicted in the display illustrated in FIG. 2b. The display of FIG. 2b includes a window 218, such as a pop-up window, informing the user that it appears the user is shopping at a detected location of Fred's Foods, and providing buttons 220a and 220b, which may be selected by the user to either confirm the identified merchant (button 220b) or reject the identified merchant (button 220a). The user may interact with the touch-sensitive display device 206 to select either button 220a or 220b.

Referring now to FIG. 2c, in one embodiment described above, the application may detect the location of the mobile device, and receive an identification of multiple possible merchants corresponding to the location from the payment services provider or based on its own determination. Accordingly, the user may be presented with the display illustrated in FIG. 2c. The display of FIG. 2c includes a window 222 presenting the user with three options with corresponding buttons 224a-224c, requesting that the user confirm he or she is shopping at one of the three options. Further, the window 222 presents the user with a fourth option with a corresponding button 224d for selection by the user if none of the displayed options correspond to the merchant where the user is shopping. The user may interact with the touch-sensitive display device 206 to select any of buttons 224a-224d, depending on the merchant where the user is shopping.

The method 100 then proceeds to block 108, where characteristics of the merchant and promotions are received from the payment services provider. In one embodiment, the characteristics of the merchant may include a merchant categorization. For example, certain credit cards offer different rewards or incentives based on the category of the merchant. As one example, a credit card may offer 5% cash back for use at a gas station, 3% cash back for use at grocery stores, and 1% cash back for use at all other merchants. In one embodiment, the promotions may be offered by an entity associated with a payment source stored in the application on the mobile device of the user. For example, promotions offered by an entity associated with a payment source may include reward points offered by a credit card issuing bank. As one example, a credit card issuing bank may offer consumers having a particular credit card a fixed number of airline miles per dollar spent using that credit card. In one embodiment, the promotions may be offered by the merchant corresponding to the detected location of the mobile device. For example, the merchant may offer a discount for using a particular payment method. As one example, the merchant may offer a 2% discount if a consumer pays using a debit card instead of a credit card, as the merchant may not need to pay the credit card processor fees for the transaction, and may pass that savings along to the consumer. In one embodiment, such promotions are not known by consumers (i.e., the offers are non-public), but are known only to the payment services provider or the credit card issuing banks or other institutions, and the consumer is only informed of such promotions at or near the time of payment. Other promotions or promotional offers may be provided to the user as well.

In one embodiment, promotions may be received from the payment services provider, which may in turn receive the promotions from the entity (e.g., credit card issuing bank) associated with a payment source. For example, in one embodiment, the payment services provider may transmit to the issuing bank an indication of a likely transaction between a user and a particular merchant, and may transmit to the issuing bank certain details of the transaction, such as the amount of the transaction, the merchant corresponding to the transaction, or the items to be purchased in the transaction. The issuing bank may choose to offer that user a special promotion to entice the user to use its credit card over other payment sources. For example, the issuing bank may offer that user a promotion that is not currently active for other customers, but which may help the issuing bank's likelihood that its credit card is used for the transaction. In one embodiment, the details transmitted from the payment services provider include no identifying information of the user. In one embodiment, the details transmitted from the payment services provider include identifying information of the user, so that the entity or issuing bank can target promotions to individual customers. In certain embodiments, the consumer must opt-in to such targeting.

In one embodiment, the payment services provider may receive promotions, including non-public promotions, from an entity associated with a payment source, such as a credit card issuing bank, on a periodic basis. In one embodiment, the payment services provider and entity associated with the payment source may collaborate on a standardized data protocol to exchange promotion information, using, for example, extensible markup language (XML) or another data format. The information received may instruct the payment services provider to offer a particular promotion to a certain percentage of users, and may allow the payment services provider to determine which users are offered the promotion. In one embodiment, as described above, such promotions are non-public promotions not known to users or consumers, but maintained by the payment services provider or entity associated with the payment source, and are only offered for limited time periods to users matching the desired criteria at the time of payment, or as an incentive to pay with a certain payment source.

The method 100 then proceeds to block 110, where a suggested payment source for the transaction between the merchant and the user of the mobile device is determined. In one embodiment, the suggested payment source is determined by the application executing on the mobile device. In one embodiment, the suggested payment source may be determined by the payment services provider. In one embodiment, the suggested payment source is determined based on the one or more stored payment sources, the characteristics of the merchant, and the one or more promotions, including one or more promotions provided by an entity associated with a payment source which is not publicly available (i.e., non-public promotions). As one example, the merchant may be a grocery store, and the payment source determined may be a grocery store credit card which offers 2% back on grocery purchases, with an extra 1% cash back to a particular class of users or individual users sharing a characteristic desired by an entity associated with the payment source. In one embodiment, additional information is used to determine the suggested payment source for the transaction. For example, details of the transaction, such as an amount of the transaction, the items purchased in the transaction, and other information, may be used to determine the suggested payment source. In one embodiment, a payment services provider device or the mobile device of the user may store data to be used in the determination of suggested payment sources for presentation to users of the payment application.

In one embodiment, the application executing on the mobile device, or the payment services provider, may incorporate other information, such as one or more payment source determination factors, to determine the payment source for the transaction. For example, in one embodiment, the determination may be based on a utilization percentage of a particular payment source, if that payment source is a credit card. The utilization percentage is a percentage of the current balance on the credit card account in relation to the total amount of credit extended to the consumer on the credit card. If the percentage is high, the consumer's credit score may be lowered. Accordingly, in one embodiment, the determination at block 110 may consider the utilization percentages of credit card payment sources, and may seek to minimize or eliminate increases of a utilization percentage past a threshold. In one embodiment, the threshold may be set by a user, for example, in a setting in the application executed by the mobile device. The user may specify a threshold for each payment source, or may specify a global threshold for all payment sources. In one embodiment, the threshold may be a recommended threshold provided by the payment services provider or by a credit card issuing bank. In one embodiment, the application or payment services provider may determine a payment source to equalize balances across multiple payment sources. In one embodiment, the balance limit of the user's payment source may be considered, and the determination at block 110 may provide for selection the payment source having the highest balance limit. Furthermore, in one embodiment, the user's credit score may be considered as a factor in determining a suggested payment source. In one embodiment, the application executing on the mobile device may request, from entities associated with payment sources stored within the application, promotional offers or incentive offers which are not offered to other users, but which may be offered to the particular user of the application at the time of the purchase. Such offers may be non-public offers that are only provided to the user for a limited time, advance offers provided to the user before other users, special offers provided to the user as a one-time or multiple-time special offer, or other such non-public offers.

In one embodiment, the determination at block 110 may consider an interest rate of a credit card or other debt-based payment source. For example, if a user has three credit cards, one with an annual percentage rate (APR) of 5%, one with an APR of 10%, and one with an APR of 19%, in one embodiment, the application or payment services provider may choose the credit card with an APR of 5%.

In one embodiment, the determination at block 110 may consider the user's current rewards point balance before recommending a particular payment source. For example, one payment source of the user may be a credit card that offers hotel rewards points, while another payment source may be a debit card offering cash back. The user may have amassed a large amount of hotel rewards points, but may not need to increase his or her balance of hotel rewards points. Accordingly, the user may set a preference to not choose the hotel rewards credit card. Thus, the application or payment services provider may determine the debit card as the payment source at block 110, in response to the user's preference. In one embodiment, the user may periodically update his or her rewards point balances in a setting in the application. Additionally, the application may periodically receive the rewards point balance from the credit card issuing bank.

In one embodiment, the application or payment services provider may utilize multiple factors for the determination at block 110, and weight factors according to the user's preferences. For example, some consumers pay off their full credit card balance monthly, and are therefore unaffected by interest rates of their credit cards. Accordingly, in the preceding example, the user may set a preference to ignore interest rate-based comparisons, and instruct the application to determine a payment source only on promotions or rewards. Any of the factors described herein may be included in the user's preferences, in one embodiment, and the user may rank each factor according to his or her desires, and change the rankings at any time. In one embodiment, a simple ranking may be used. Additionally, weighting factors may be used to give the user finer-grained control over recommendations.

The method 100 then proceeds to block 112, where the suggested payment source is displayed on the touch sensitive display device for selection by the user of the mobile device. In one embodiment, the suggested payment source is displayed with graphics or artwork indicative of the funding source. For example, an AMERICAN EXPRESS credit card may be displayed with appropriate branding information. Funding from a bank account may appear as a virtual check. In one embodiment, the suggested payment source is displayed as text only, or may be rendered in combination with an audio file instructing the user to pay with the recommended payment source. In one embodiment, the displayed payment source may provide an indication of the factors used for the determination (e.g., rewards points for the transaction if the determined payment source is used, APR for the payment source, etc.)

Referring now to FIG. 2d, the application executing on the payer device 200 may provide a screen on display 206 with a window 226 informing the user of the recommended payment source, in this case, the user's AMERICAN EXPRESS card. The display of FIG. 2d depicts in window 226, as a carousel, the user's payment sources, with the recommended payment source appearing larger than the others, and in the center position of the display.

Additionally, window 226 includes a button 228 which may be selected by the user to receive additional information on the reasons for the determination. Window 226 also includes a PAY button 230 which may be selected by the user to pay with the determined funding source, as described below. The user may interact with the touch-sensitive display device 206 to select button 228.

Referring now to FIG. 2e, the application executing on the payer device, in response to a selection of button 228 using the touch-sensitive display device, may provide a further pop-up window 232 informing the user of the reasons the suggested payment source was determined or recommended. For example, the pop-up window 232 of FIG. 2e states that the chosen payment source has the lowest interest rate, and the credit card issuing bank for the payment source is offering the user a special promotion for the day. The pop-up window 232 may also include a button 234 to close the pop-up window.

At block 114 then, a selection of the suggested payment source by the user of the mobile device may be received using the touch-sensitive display. In response, the mobile device may associate the transaction with the suggested payment source for tracking and budgeting purposes, in one embodiment. In one embodiment, the mobile device may wirelessly (e.g., using near-field communication or Bluetooth) transmit payment details corresponding to the suggested payment source to a payment terminal. In one embodiment, the mobile device may cause the generation of a transaction identifier, such as a bar code or two dimensional quick response (QR) code, which encodes payment details corresponding to the suggested payment source, and which may then be scanned by the merchant to receive payment details corresponding to the suggested payment source.

Referring now to FIG. 2f, in response to the selection of the PAY button 230 as depicted in FIG. 2d, the application executing on the payer device 200 may provide a screen on display 206 with a window 236 informing the user of how to pay with the recommended payment source. For example, the display of FIG. 2f includes in window 236 an instruction to place the user's mobile device near a near-field communication pay target. In response, the application executing on the user's mobile device may wirelessly transmit an identification of the payment source to the merchant for completion of the transaction. As described above, in one embodiment, activation of the of the PAY button 230 may cause the generation of a transaction identifier, such as a bar code or QR code. In one embodiment, if near-field communication payment, wireless payment, or payment via transaction identifier is not available at the merchant location, activation of the PAY button may dismiss the window 236. In one embodiment, activation of the PAY button may prompt the user to enter in transaction details, such as the amount of the transaction, if the user wishes to have the application track or maintain a record of his or her transactions.

In one embodiment, the user may choose a different payment source than the suggested payment source. Thus, in one embodiment, the user may utilize the touch-sensitive display device to discard the suggested payment source, for example, by swiping the displayed recommended payment source to the right or left or other direction. In one embodiment, the user may interact with the touch-sensitive display device to open a menu or other selectable options to choose a different payment source.

Referring now to FIG. 2g, a directional touch input 238 corresponding to a swipe input towards the right edge of the touch-sensitive display device 202 is depicted. As one example, the user may touch the touch-sensitive display device 202 (as indicated by element 239) and drag his or her finger across the screen the touch-sensitive display device 202 (as indicated by element 238) to perform the directional touch input 240 illustrated in FIG. 2g. In another embodiment, a stylus may be used to provide the directional touch input 231 substantially as discussed above. In response to the directional touch input, a different payment source may be displayed, which the user may then use to pay for the transaction.

In one embodiment, the determination at block 110 may result in an application for a new payment source being offered to the user. For example, the payment services provider may have a relationship with a credit card issuing bank or other institution in which the credit card issuing bank provides details of consumers it wishes to have as customers. In response to the receipt of information identifying a particular merchant and a user's identification, the payment services provider may provide the user an application for a new credit card or other payment source that provides the user an incentive, promotion, or rewards points that the user does not currently have in his or her stored payment options. In one embodiment, the user may be offered an additional incentive for opening the new credit card beyond what the credit card would offer if ordinarily being used for a purchase. In one embodiment, the user's application for the new credit card has certain information fields pre-filled from its account details with the payment services provider.

Referring now to FIG. 2h, the application executing on the payer device 200 may provide a screen on display 206 with a window 238 informing the user of an offer to apply for a new payment source in exchange for a 5% discount on purchases. The display of FIG. 2h depicts in window 238 the offer for the new payment source. Additionally, window 238 includes buttons 240a and 240b which may be selected by the user to apply for the payment source or to decline the offer to apply. The user may interact with the touch-sensitive display device 206 to select either button 240a or 240b.

In one embodiment, the determination of which payment source to use does not occur during the transaction between the merchant and the consumer. Instead, the payment services provider may operate as an intermediary for real-time processing and payment for the transaction. Thus, the payment services provider acts initially as the payment source for a transaction. For example, the payment services provider may deduct funds from the “Available Balance” of the user's account with the payment services provider. In one embodiment, the “Available Balance” of the user's account may include his or her access to lines of credit, such as credit card accounts. At a later time, the user may review his or her transactions, and may assign one or more transactions to specific payment sources. In one embodiment, the user is presented a suggested payment source for each transaction, and may be able to filter or sort through transactions based on a suggested payment source, or based on which payment sources are offering non-public promotions. In one embodiment, the payment services provider may process multiple transactions grouped together by suggested payment sources to minimize fees paid to entities associated with those suggested payment sources. In one embodiment, fees charged by those entities may be recovered from merchants associated with the particular transactions.

In one embodiment, the payment services provider or the application executing on the mobile device of the user may collect and integrate with other services and applications utilized by the user. For example, the application may request access to and gain access to the user's calendar. If the application detects that the user has a future event, such as a wedding, birthday, or other gift-giving event, the application may recommend a gift, a payment source, and/or a merchant for that event to provide the most reward points, the lowest APR, the least effect on credit score, a non-public promotion, or any other criteria desired by the user. In other examples, the payment services provider or the application executing on the mobile device may communicate with a shopping list application, or a reminder application, to identify items to be purchased in the near future, and recommend or suggest a payment source for those items. In one embodiment, interactions and data exchange with other applications or other data sources may utilize application programming interfaces (APIs) provided by the developers of those applications or data sources. For example, a calendar application or website may offer a standard API for read and write access, and the application or payment services provider may utilize to API for analyzing future events and recommending payment sources.

In one embodiment, the application or payment services provider may access previous purchases of the user, e.g., utilizing previous credit card or bank statements, and use this data as training data for future recommendations of payment sources. For example, the application may access the user's last three months of statements to learn the user's purchasing habits, and in response, provide recommended payment sources at certain times during the month when the user is likely to need a payment source for an expected clothing transaction or grocery transaction. Thus, in one embodiment, the payment services provider or the application executing on the mobile device of the user may use historical data to recommend a payment source, or to provide other information to the user. For example, the application may analyze previous purchases to determine that every Sunday, the user of the mobile device goes on his weekly grocery shopping trip. Accordingly, the application may present the user with a reminder on Sunday morning to use a particular payment source that provides the best reward points for grocery shopping, or a particular payment source that may be offering the user a non-public promotion. Alternatively, the application may present the user an offer to use a payment source he would ordinarily not use for the grocery trip based on a different incentive (coupon, etc.). In one embodiment, the application may present recommendations regarding particular products to purchase on an upcoming visit or trip to a particular merchant based on previous purchase or other data, and may present information regarding promotions or other offers related to those products. For example, if the user's previous purchases indicate an interest in movies for viewing at home, the application may present a recommendation to purchase a Brand C television, and a promotional offer from an entity associated with a payment source to receive extra cash back if the Brand C television is purchased on the upcoming shopping trip. In one embodiment, the application may provide one or more merchant options for purchasing recommended products, with details regarding savings or other promotional offers for each merchant option.

In one embodiment, the user may save information regarding promotions or other incentive offers, which may be saved in association with the user's account with the payment services provider. In some embodiments, when the user is within a predetermined distance of a location of the merchant associated with a promotion (e.g., a merchant that offers bonus rewards points for a transaction with a particular payment source), or traveling in a direction towards a location of the merchant associated with a promotion, the application provided by the payment services provider may present a previously-saved promotional offer to the user (e.g., in a “pop-up” window, a lock-screen notification, via an automatically launching payment application, etc.), so as to remind the user of the promotional offer when it is particularly relevant or likely to become relevant (i.e., at a time when the user will be able to easily use it because they are close to the merchant or traveling in the direction of the merchant), along with a reminder to use a particular payment source for the transaction.

In one embodiment, information regarding which incentive offers have been saved, discarded, shared, and/or had notes added to them, may be used for other purposes. For example, in one embodiment, the information regarding the incentive offers that have been saved may be used in the wallet portion of the application to recommend other merchants to the user that they may be interested in, or recommend certain products or services to the user that they may be interested in, or to recommend payment sources to the user that they may be interested in. The use of such information may not be limited to the application provided by the payment services provider executing on the mobile device described above, and instead may be used to present relevant information, for example, on websites using a toolbar provided by the payment services provider in a web browser.

In one embodiment, the application may permit a user to move balances from one credit card or payment source to another, based on incentives given for doing so, or based on a lower interest rate. For example, on a periodic or on-demand basis, the application may connect to the user's various payment sources (e.g., bank accounts, credit cards, etc.), and determine whether a balance of a particular payment source is relatively higher than others, and ask the user if he or she would like to transfer the balance. In one embodiment, the first time the user does so, he or she may be offered a promotion to transfer balances (lower fees, for example), which may entice the user to transfer balances in the future. In one embodiment, the application may apply a payment from the user's bank account to one or more credit card accounts to lower the balance on the credit card account.

In one embodiment, the application or payment services provider may have access to the user's payment sources, such as bank accounts, and recommend a payment source or recommend not purchasing a product from the merchant if the user has savings goals entered in as an option. For example, the user may utilize an option in the application to establish a savings goal of $500 per month. If the application analyzes the user's past purchases and a current purchase, and determines that the user is not likely to meet that goal, the application may warn the user of such a possibility, and recommend taking actions, such as searching for less expensive products, searching for discounts or offers on comparable products, or not purchasing the particular product.

Referring now to FIG. 2i, in response to selecting a settings option or button, such as settings button 216d, the application executing on the payer device 200 may provide a screen on display 206 with a window 242 presenting various options and preferences the user may select. The display of FIG. 2i includes an option 244a allowing the user to rank his or her payment source recommendation factors; in the example of FIG. 2i, the user has chosen to make APR the most important factor, with cash back and rewards points as second and third, respectively. As option 244b, the user has selected to receive offers for payment sources that may be of interest. As option 244c, the user has granted access to calendar data to recommend payment sources for upcoming purchases. As option 244d, the user has entered a savings goal which may be used to determine suggested payment sources. Finally, the display of FIG. 2i includes a Save Settings button 246 allowing the user to commit or save the entered settings. The user may interact with the touch-sensitive display device 206 to enter any of the options 244a-244d and commit or save the settings using button 246.

Thus, systems and methods have been described that provide for the recommendation of payment sources. The systems and methods may present a recommended payment source for a transaction to a user based on the user's location, features of his or her payment sources, and/or details of the transaction, and the user may quickly and easily select the payment source for use. As such, the recommendation of payment sources assists the user in the use of recommended payment sources to maximize reward points, minimize interest accrual, or accomplish any other financial goal of the user. In addition, merchants and financial institutions may benefit from lower fees on transactions, or from new customers signing up for new payment sources.

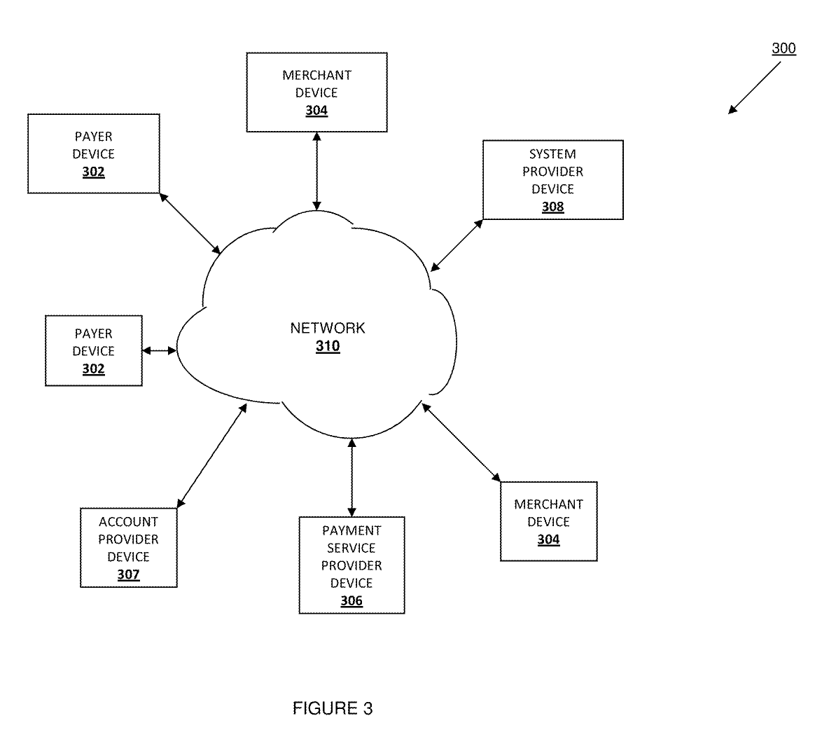

Referring now to FIG. 3, an embodiment of a network-based system 300 for implementing one or more processes described herein is illustrated. As shown, network-based system 300 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 3 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 300 illustrated in FIG. 3 includes a plurality of payer devices 302, a plurality of merchant devices 304, a payment services provider device 306, an account provider device 307, and/or a system provider device 308, in communication over a network 310. Any of the payer devices 302 may be the payer device 200 operated by the users, discussed above. The merchant devices 304 may be the merchant devices discussed above and may be operated by the merchants discussed above. The payment services provider device 306 may be the payment services provider devices discussed above and may be operated by a payment services provider such as, for example, PayPal Inc. of San Jose, Calif. The account provider devices 307 may be the account provider devices discussed above and may be operated by the account providers discussed above such as, for example, credit card account providers, bank account providers, savings account providers, and a variety of other account providers known in the art. The system provider device 308 may be the system provider devices discussed above and may be operated by the system providers discussed above.

The payer devices 302, merchant devices 304, payment services provider device 306, account provider device 308, and/or system provider device 308 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 300, and/or accessible over the network 310.

The network 310 may be implemented as a single network or a combination of multiple networks. For example, in various embodiments, the network 310 may include the Internet and/or one or more intranets, landline networks, wireless networks, and/or other appropriate types of networks.

The payer device 302 may be implemented using any appropriate combination of hardware and/or software configured for wired and/or wireless communication over network 310. For example, in one embodiment, the payer device 302 may be implemented as a personal computer of a user in communication with the Internet. In other embodiments, the payer device 302 may be a smart phone, personal digital assistant (PDA), laptop computer, and/or other types of computing devices.

The payer device 302 may include one or more browser applications which may be used, for example, to provide a convenient interface to permit the payer to browse information available over the network 310. For example, in one embodiment, the browser application may be implemented as a web browser configured to view information available over the Internet.

The payer device 302 may also include one or more toolbar applications which may be used, for example, to provide user-side processing for performing desired tasks in response to operations selected by the payer. In one embodiment, the toolbar application may display a user interface in connection with the browser application.

The payer device 302 may further include other applications as may be desired in particular embodiments to provide desired features to the payer device 302. In particular, the other applications may include a payment application for payments assisted by a payment services provider through the payment services provider device 306. The other applications may also include security applications for implementing user-side security features, programmatic user applications for interfacing with appropriate application programming interfaces (APIs) over the network 310, or other types of applications. Email and/or text applications may also be included, which allow the payer to send and receive emails and/or text messages through the network 310. The payer device 302 includes one or more user and/or device identifiers which may be implemented, for example, as operating system registry entries, cookies associated with the browser application, identifiers associated with hardware of the payer device 302, or other appropriate identifiers, such as a phone number. In one embodiment, the user identifier may be used by the payment services provider device 306 and/or account provider device 307 to associate the user with a particular account as further described herein.

The merchant device 304 may be maintained, for example, by a conventional or on-line merchant, conventional or digital goods seller, individual seller, and/or application developer offering various products and/or services in exchange for payment to be received conventionally or over the network 310. In this regard, the merchant device 304 may include a database identifying available products and/or services (e.g., collectively referred to as items) which may be made available for viewing and purchase by the payer.

The merchant device 304 also includes a checkout application which may be configured to facilitate the purchase by the payer of items. The checkout application may be configured to accept payment information from the user through the payer device 302, the account provider through the account provider device 307, and/or from the payment services provider through the payment services provider device 306 over the network 310.

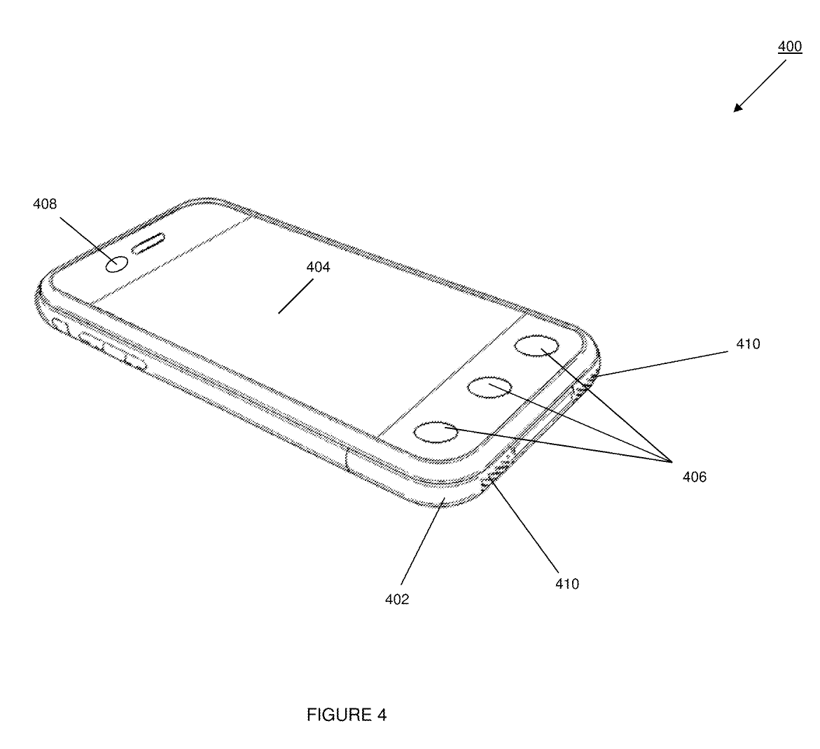

Referring now to FIG. 4, an embodiment of a payer device 400 is illustrated. The payer device 400 may be the payer devices 200 and/or 302. The payer device 400 includes a chassis 402 having a display 404 and an input device including the display 404 and a plurality of input buttons 406. The payer device 400 further includes a camera 408 and one or more audio input/output devices (e.g., microphones, speakers) 410. One of skill in the art will recognize that the payer device 400 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

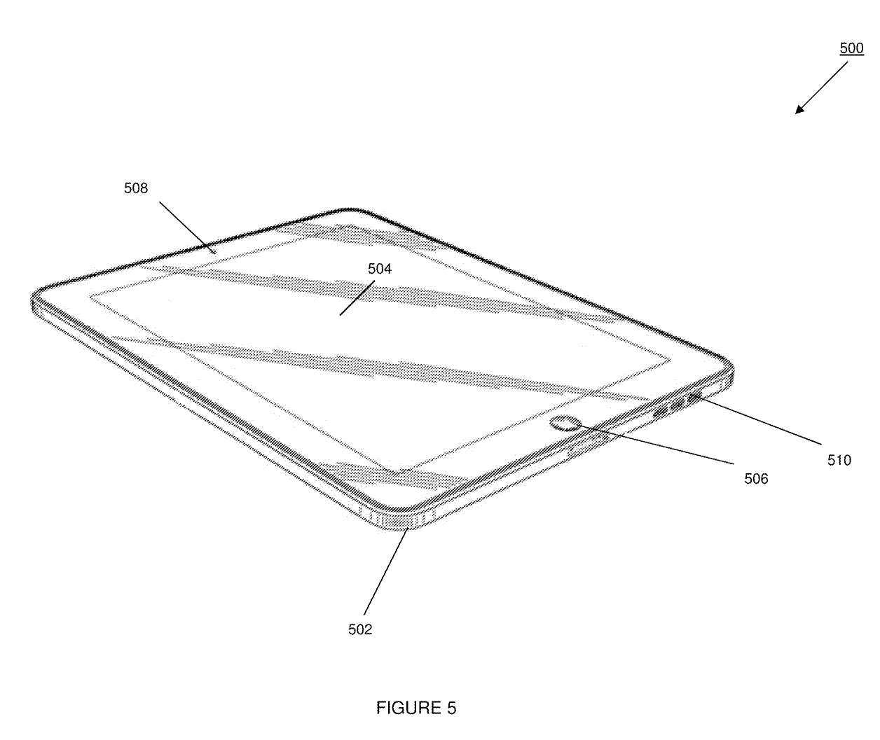

Referring now to FIG. 5, a further embodiment of a payer device 500 is illustrated. The payer device 400 may be the payer devices 200 and/or 302. The payer device 500 includes a chassis 502 having a display 504 and an input device including the display 504.

The payer device 500 may also include an input button 406 and one or more audio input/output device 508 (e.g. microphones, speakers). One of skill in the art will recognize that the payer device 500 is a portable or mobile table device including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

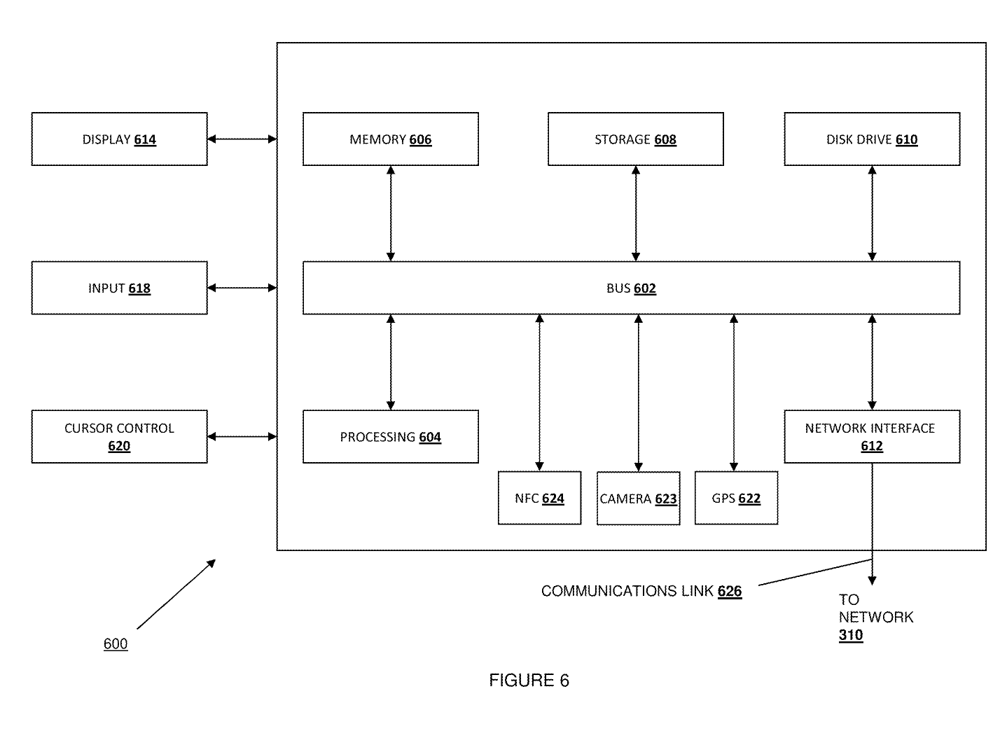

Referring now to FIG. 6, an embodiment of a computer system 600 suitable for implementing, for example, the payer device 200, the payer device 302, the payer device 400, the payer device 500, the merchant devices 304, the payment services provider device 306, the account provider device 307, and/or the system provider device 308, is illustrated. It should be appreciated that other devices utilized by payers, merchants, payment services providers, account providers, and system providers in the system discussed above may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT, LCD, touch-sensitive display device, etc.), an input component 618 (e.g., keyboard, keypad, virtual keyboard, touch-sensitive display device), a cursor control component 620 (e.g., mouse, pointer, or trackball), a location determination component 622 (e.g., a Global Positioning System (GPS) device as illustrated, a cell tower triangulation device, a Wi-Fi triangulation device, a Bluetooth-based location device, and/or a variety of other location determination devices known in the art), and/or a camera device 623. The computer system 600 may also include a near-field communication (NFC) component 624, or other radio frequency identification component, installed therein allowing the device to be operated pursuant to ISO/IEC 18092, NFC IP-1 or the ISO/IEC 14443 contactless communication standards, or other applicable contactless communication standards and wireless technologies including but not limited to those for Bluetooth and Bluetooth Low Energy (BLE) and NFC. In one implementation, the disk drive component 610 may comprise a database having one or more disk drive components.

In accordance with embodiments of the present disclosure, the computer system 600 performs specific operations by the processor 604 executing one or more sequences of instructions contained in the memory component 606, such as described herein with respect to the payer devices 200, 302, 400 and 500, the merchant device(s) 304, the payment services provider device 306, the account provider device(s) 307, and/or the system provider device 308. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 600. In various other embodiments of the present disclosure, a plurality of the computer systems 600 coupled by a communication link 626 to the network 310 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 626 and the network interface component 612. The network interface component 612 may include an antenna, either separate or integrated, to enable transmission and reception via the communication link 626. Received program code may be executed by processor 604 as received and/or stored in disk drive component 610 or some other non-volatile storage component for execution.

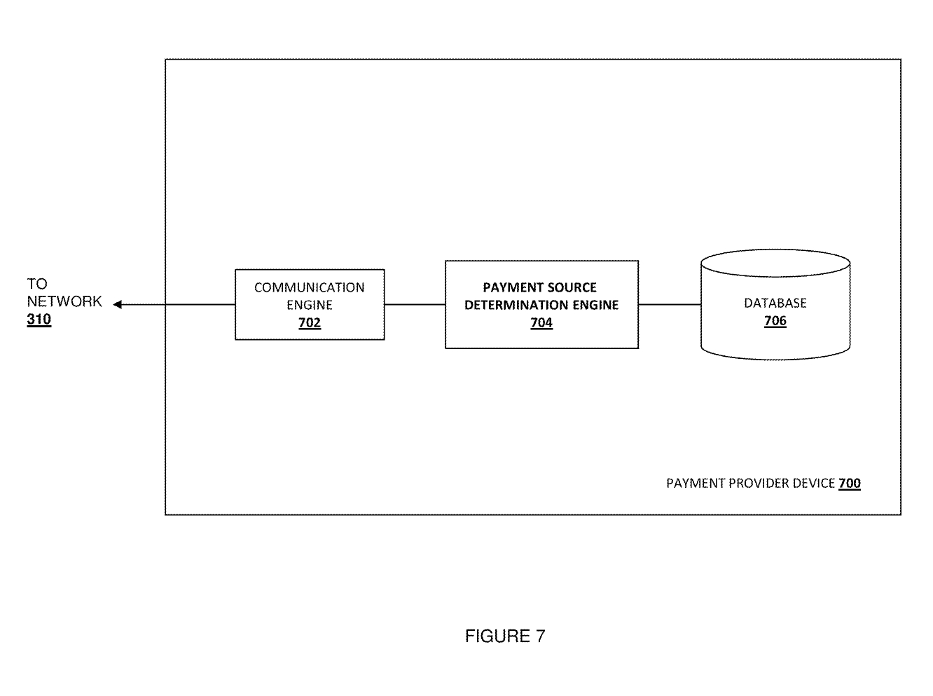

Referring now to FIG. 7, an embodiment of a payment provider device 700 is illustrated. In an embodiment, the device 700 may be the system provider device 308 discussed above. The device 700 includes a communication engine 702 that is coupled to the network 310 and to a payment source determination engine 704 that is coupled to a database 706. The communication engine 702 may be software or instructions stored on a computer-readable medium that allows the device 700 to send and receive information over the network 310. The payment source determination engine 704 may be software or instructions stored on a computer-readable medium that is operable to detect or receive a location of a mobile device using a location detection sensor, transmit or receive a detected location, identify a merchant corresponding to the detected location, receive or identify characteristics of the merchant and promotions offered by an entity associated with a stored payment source or offered by the merchant, determining a suggested payment source for a transaction between the merchant and a user of a mobile device, display a suggested payment source for selection, and receive a selection of the suggested payment source. While the database 706 has been illustrated as located in the payment provider device 700, one of skill in the art will recognize that it may be connected to the payment source determination engine 704 through the network 310 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile device system, comprising:
a non-transitory memory storing a plurality of payment sources associated with a user of the mobile device;
one or more location detection sensors;
a touch-sensitive display; and
one or more hardware processors coupled to the non-transitory memory, the one or more location detection sensors, and the touch-sensitive display, wherein the one or more processors are configured to read instructions from the non-transitory memory to cause the system to perform operations comprising:
detecting, using the one or more location detection sensors, a location of the mobile device;
transmitting, to a payment services provider, the detected location of the mobile device;
identifying a merchant corresponding to the detected location of the mobile device;
receiving, from the payment services provider, one or more characteristics of the merchant corresponding to the detected location of the mobile device, and one or more non-public promotions offered by an entity associated with one or more of a stored payment source and the merchant;
determining, based on the one or more payment sources, the one or more characteristics, and the one or more non-public promotions, a suggested payment source for a transaction between the merchant and the user of the mobile device; and
displaying, on the touch-sensitive display, the suggested payment source for selection by the user of the mobile device; and
receiving, using the touch-sensitive display, a selection of the suggested payment source by the user of the mobile device.

2. The system of claim 1, wherein the suggested payment source is a first suggested payment source, and wherein the one or more hardware processors are configured to read instructions from the non-transitory memory to cause the system to perform operations comprising:
receiving, using the touch-sensitive display, a directional touch input from the user of the mobile device, and
displaying, on the touch-sensitive display, a second suggested payment source based on the one or more payment sources.

3. The system of claim 1, wherein the one or more hardware processors are configured to read instructions from the non-transitory memory to cause the system to perform operations comprising:
receiving, using the touch-sensitive display, one or more payment source determination factors; and
determining, based on the one or more payment sources, the one or more payment source determination factors, the one or more characteristics, and the one or more non-public promotions, the suggested payment source for the transaction between the merchant and the user of the mobile device.

4. The system of claim 1, wherein the one or more hardware processors are configured to read instructions from the non-transitory memory to cause the system to perform operations comprising:
displaying, on the touch-sensitive display, an offer directed to the user of the mobile device to apply for a payment source not in the plurality of payment sources associated with the user of the mobile device.

5. The system of claim 1, wherein the one or more processors are configured to read instructions from the non-transitory memory to cause the system to perform operations comprising:
displaying, on the touch sensitive display, an indication of one or more factors used in the determination of the payment source for the transaction.

6. The system of claim 1, further comprising a near-field communication component, and wherein the one or more processors are configured to read instructions from the non-transitory memory to cause the system to perform operations comprising:
transmitting, via the near-field communication component, payment information corresponding to the suggested payment source for the transaction.

7. The system of claim 1, wherein the one or more processors are configured to read instructions from the non-transitory memory to cause the system to perform operations comprising:
transmitting, from the mobile device, details of the transaction to an entity associated with a stored payment source.

8. A computer-implemented method for providing suggested payment sources to a user of a mobile device, comprising:
detecting, using one or more location detection sensors of the mobile device, a location of the mobile device;
transmitting, to a payment services provider, the detected location of the mobile device;
identifying a merchant corresponding to the detected location of the mobile device;
receiving, from the payment services provider, one or more characteristics of the merchant corresponding to the detected location of the mobile device, and one or more non-public promotions offered by an entity associated with one or more of a stored payment source in a plurality of stored payment sources associated with the user and the merchant;
determining, based on the plurality of stored payment sources associated with the user, the one or more characteristics, and the one or more non-public promotions, a suggested payment source for a transaction between the merchant and the user of the mobile device; and
displaying, on a touch-sensitive display of the mobile device, the suggested payment source for selection by the user of the mobile device; and
receiving, using the touch-sensitive display, a selection of the suggested payment source by the user of the mobile device

9. The method of claim 8, wherein the suggested payment source is a first suggested payment source, and wherein the method further comprises receiving, using the touch-sensitive display, a directional touch input from the user of the mobile device; and displaying, on the touch-sensitive display, a second suggested payment source based on the one or more payment sources.

10. The method of claim 8, the method further comprising:
receiving, using the touch-sensitive display, one or more payment source determination factors; and
determining, based on the one or more payment sources, the one or more payment source determination factors, the one or more characteristics, and the one or more non-public promotions, the suggested payment source for the transaction between the merchant and the user of the mobile device.

11. The method of claim 8, further comprising:
displaying, on the touch-sensitive display, an offer directed to the user of the mobile device to apply for a payment source not in the plurality of payment sources associated with the user.

12. The method of claim 8, further comprising:
displaying, on the touch sensitive display, an indication of one or more factors used in the determination of the suggested payment source for the transaction.

13. The method of claim 8, further comprising:
transmitting, via a near-field communication component, payment information corresponding to the suggested payment source for the transaction.

14. The method of claim 8, further comprising transmitting, from the mobile device, details of the transaction to an entity associated with a stored payment source.

15. A non-transitory machine-readable medium having stored thereon machine-readable instructions executable to cause a machine to perform operations comprising:
detecting, using one or more location detection sensors, a location of a mobile device;
transmitting, to a payment services provider, the detected location of the mobile device;
identifying a merchant corresponding to the detected location of the mobile device;
receiving, from the payment services provider, one or more characteristics of the merchant corresponding to the detected location of the mobile device, and one or more non-public promotions offered by an entity associated with one or more of a stored payment source in a plurality of stored payment sources associated with the user and the merchant;
determining, based on the plurality of stored payment sources, the one or more characteristics, and the one or more non-public promotions, a suggested payment source for a transaction between the merchant and a user of the mobile device; and
displaying, on a touch-sensitive display, the suggested payment source for selection by the user of the mobile device; and
receiving, using the touch-sensitive display, a selection of the suggested payment source by the user of the mobile device.

16. The non-transitory machine-readable medium of claim 15, wherein the suggested payment source is a first suggested payment source, and wherein the method further comprises receiving, using the touch-sensitive display, a directional touch input from the user of the mobile device, and displaying, on the touch-sensitive display, a second payment source based on the one or more payment sources.

17. The non-transitory machine-readable medium of claim 15, wherein the method further comprises:
receiving, using the touch-sensitive display, one or more payment source determination factors; and
determining, based on the one or more payment sources, the one or more payment source determination factors, the one or more characteristics, and the one or more promotions, the suggested payment source for the transaction between the merchant and the user of the mobile device.

18. The non-transitory machine-readable medium of claim 15, wherein the method further comprises:
transmitting, via a near-field communication component, payment information corresponding to the suggested payment source for the transaction.

19. The non-transitory machine-readable medium of claim 15, wherein the method further comprises:
displaying, on the touch-sensitive display, an offer directed to the user of the mobile device to apply for a payment source not in the plurality of payment sources associated with the user of the mobile device.

20. The non-transitory machine-readable medium of claim 15, wherein the method further comprises:
displaying, on the touch sensitive display, an indication of one or more factors used in the determination of the payment source for the transaction.
